(19) United States
(12) Patent Application Publication
(10) Pub. No.: US 2021/0333184 A1
(43) Pub. Date: Oct. 28, 2021

(54) METHOD FOR PREDICTING A CREEP FRACTURE BEHAVIOR OF WOVEN CERAMIC MATRIX COMPOSITE MATERIAL CONSIDERING RANDOM LOAD EFFECT

(71) Applicant: Nanjing University of Aeronautics and Astronautics, Nanjing (CN)

(72) Inventor: LONGBIAO LI, Nanjing (CN)

(21) Appl. No.: 17/016,339

(22) Filed: Sep. 9, 2020

(30) Foreign Application Priority Data
Apr. 24, 2020 (CN) 202010331013. 2

(51) Int. Cl. G01N 3/56; C04B 35/622

(52) U.S. Cl. CPC G01N 3/56; C04B 35/62231

(57) ABSTRACT

A method for predicting a creep fracture behavior of a woven ceramic matrix composite is provided. A fiber axial stress distribution equation is obtained according to a shear lag model, a random matrix cracking model, a fracture mechanical interface debonding criterion and a fiber failure model; a matrix crack spacing equation is obtained according to the random matrix cracking model; an interface debonding length equation is obtained according to the fracture mechanics interface debonding criterion, and an equation of the load bearing relationship between intact fibers and broken fibers and a fiber fracture probability equation are obtained based on an overall load bearing criterion; and at last a creep strain equation of the woven ceramic matrix composite material is obtained, according to the overall load bearing criterion, to predict the creep fracture behavior of the woven ceramic matrix composite material affected by the random load.

### TECHNICAL FIELD

The disclosure relates to a technical field of method for predicting a creep fracture behavior of a woven ceramic matrix composite material, in particular to a method for predicting a creep fracture behavior of a woven ceramic matrix composite material considering a random load effect.

### BACKGROUND

The woven ceramic matrix composite material has advantages of high temperature resistance, corrosion resistance, low density, high specific strength, high specific modulus and the like, and can bear higher temperature, reduce cooling airflow and improve turbine efficiency compared with high-temperature alloy, which is thus applied to aeroengine combustors, turbine guide blades, turbine shell rings, tail nozzles and the like at present. In an LEAP (leading Edge Aviation Propulsion) series of engines developed by CFM Corporation, a high-pressure turbine adopts a woven ceramic matrix composite material component, wherein LEAP-1B engine provides power for Airbus A320 and Boeing 737MAX, and LEAP-X1C engine provides power for large aircraft C919.

In order to ensure reliability and safety of the woven ceramic matrix composite material used in structures of aircrafts and aeroengines, the development of tools for performance evaluation, damage evolution, strength and life prediction of the ceramic matrix composite material is used as a key of airworthiness certification of structural components made of the ceramic matrix composite material by researchers at home and abroad. Under an action of a creep random load, multiple damage mechanisms, such as matrix multi-cracking, fiber/matrix interface debonding and slipping, and fiber fracture, occurred in the woven ceramic matrix composite material.

How to consider the influence of the random load factor on the creep fracture behavior of the woven ceramic matrix composite is a key technical problem to be solved in the practical engineering application of the woven ceramic matrix composite material structure.

### SUMMARY

The disclosure intends to provide a method for predicting a creep fracture behavior of a woven ceramic matrix composite material considering a random load effect, which considers the effects of random load factors on the creep fracture behavior of the woven ceramic matrix composite material and thus can accurately predict the creep fracture behavior of the woven ceramic matrix composite material affected by the random load.

In order to achieve the above effect, the disclosure provides the following solutions:

A method for predicting a creep fracture behavior of a woven ceramic matrix composite material considering a random load effect comprising:

(1) establishing a fiber axial stress distribution equation under an action of a creep random load according to a shear lag model, a random matrix cracking model, a fracture mechanical interface debonding criterion and a fiber failure model;

(2) establishing a matrix crack spacing equation under an action of a creep random load according to the random matrix cracking model;

(3) establishing an interface debonding length equation under the action of a creep random load by using the fiber axial stress distribution equation under the action of the creep random load obtained in step (1) and the matrix crack spacing equation under the action of the creep random load obtained in step (2), according to the fracture mechanics interface debonding criterion;

(4) establishing an equation of the load bearing relationship between intact fibers and broken fibers and a fiber fracture probability equation under the action of the creep random load according to an overall load bearing criterion, Weibull distribution, a mesoscopic stress field of a damaged region of the woven ceramic matrix composite material, the matrix crack spacing equation under the action of the creep random load obtained in step (2) and the interface debonding length equation under the action of the creep random load obtained in step (3); and

(5) establishing a creep strain equation under the action of the creep random load by using the fiber axial stress distribution equation under the action of the creep random load obtained in step (1), the matrix crack spacing equation under the action of the creep random load obtained in step (2), and the equation of the load bearing relationship between the intact fibers and the broken fibers and the fiber fracture probability equation under the action of the creep random load obtained in step (4), according to the overall load bearing criterion, to predict the creep fracture behavior of the woven ceramic matrix composite material under the action of the creep random load.

Optionally, in step (1), the fiber axial stress distribution equation under the action of the creep random load is as shown in formula 1:

$${σ}_{f} ( x , t ) = \{ \begin{matrix}S ( t ) - \frac{2 {τ}_{f}}{{r}_{f}} x , x ∈ [ 0 , ζ ( t ) ] \\ S ( t ) - \frac{2 {τ}_{f}}{{r}_{f}} ζ ( t ) - \frac{2 {τ}_{i}}{{r}_{f}} ( x - ζ ( t ) ) , x ∈ [ ζ ( t ) , {l}_{d} ( t ) ] \\ \begin{matrix}{σ}_{fo} + [ S ( t ) - {σ}_{fo} - \frac{2 {τ}_{f}}{{r}_{f}} ζ ( t ) - \frac{2 {τ}_{i}}{{r}_{f}} ( {l}_{d} ( t ) - ζ ( t ) ) ] exp \\ ( - ρ \frac{x - {l}_{d} ( t )}{{r}_{f}} ) , x ∈ [ {l}_{d} ( t ) , \frac{{l}_{c}}{2} ]\end{matrix}\end{matrix} ; \qquad formula 1$$

in the formula 1, σ_{f}(x,t) is a fiber axial stress, S(t) is a random load, τ_{f} is an oxidation region interface shear stress, r_{f} is a fiber radius, x is an axial value, ζ(t) is an interface oxidation length, τᵢ is a slip region interface shear stress, l_{d}(t) is an interface debonding length, σ_{fo} is an interface bonding region stress, ρ is a shear lag model parameter, and l_{c} is a matrix crack spacing.

Optionally, in step (2), the matrix crack spacing equation under the action of the creep random load is as shown in formula 2:

$${l}_{c} = {r}_{f} \frac{{V}_{m} {E}_{m}}{χ {V}_{f} {E}_{c}} \frac{{σ}_{R}}{2 {τ}_{i}} Λ {\{ 1 - exp [ - {( \frac{σ - ( {σ}_{m c} - {σ}_{t h} )}{( {σ}_{R} - {σ}_{t h} ) - ( {σ}_{m c} - {σ}_{t h} )} )}^{m} ] \}}^{1} , \qquad formula 2$$

in the formula 2, l_{c} is a matrix crack spacing, r_{f} is a fiber radius, Vₘ is matrix volume content, Em is a matrix elastic modulus, χ is a fiber effective volume content coefficient along a stress loading direction, V_{f} is fiber volume content in the composite material, E_{c} is a composite material elastic modulus, σ_{R} is a matrix cracking characteristic stress, τᵢ is a slip region interface shear stress, σ is a stress, σ_{mc} is a matrix initial cracking stress, σₜₕ is a residual thermal stress, and m is a matrix Weibull modulus.

Optionally, in step (3), the interface debonding length equation under the action of the creep random load is as shown in formula 3:

$${l}_{d} ( t ) = ( 1 - \frac{{τ}_{f}}{τ} ) ζ ( t ) + \frac{{r}_{f}}{2} ( \frac{{V}_{m} {E}_{m} S}{{E}_{c} {τ}_{i}} - \frac{1}{ρ} ) - \sqrt{{( \frac{{r}_{f}}{2 ρ} )}^{2} - \frac{{r}_{f}^{2} {V}_{f} {V}_{m} {E}_{f} {E}_{m} {S}^{2}}{4 {E}_{c}^{2} {τ}_{i}^{2}} ( 1 - \frac{σ}{{V}_{f} S} ) + \frac{{r}_{f} {V}_{m} {E}_{f} {E}_{m}}{{E}_{c} {τ}_{i}^{2}} {ξ}_{d}} ; \qquad formula 3$$

in the formula 3, 1d(t) is an interface debonding length, τ_{f} is an oxidation region interface shear stress, σᵢ is a slip region interface shear stress, ζ(t) is an interface oxidation length, r_{f} is a fiber radius, Vₘ is matrix volume content, Eₘ is a matrix elastic modulus, S represents an intact fibers bearing stress, Ec is a composite material elastic modulus, ρ is a shear lag model parameter, V_{f} is fiber volume content in the composite material, E_{f} is a fiber elastic modulus, a is a stress, and ξ_{d} is interface debonding energy.

Optionally, in step (4), the equation of the load bearing relationship between the intact fibers and the broken fibers under the action of the creep random load is as shown in formula 4-1:

$$\frac{σ}{{V}_{f}} = S ( 1 - P ( S ) ) + \frac{2 {τ}_{f}}{{r}_{f}} 〈 L 〉 P ( S ) ; \qquad formula 4 \text{-} 1$$

the fiber fracture probability equation under the action of the creep random load is as shown in formula 4-2:

$$P ( S ) = 1 - exp [ - {( \frac{S}{{σ}_{c}} )}^{{m}_{f} + 1} ] ; \qquad formula 4 \text{-} 2$$

in the formulas 4-1 and 4-2, σ is a stress, V_{f} is fiber volume content in the composite material, S represents an intact fibers bearing stress, P(S) is a fiber fracture probability, τ_{f} is an oxidation region interface shear stress, r_{f} is a fiber radius, [symbol] L [symbol] is a fiber pulling length, σ_{c} is a fiber characteristic strength, and m_{f} is a fiber Weibull modulus.

Optionally, in step (5), the creep strain equation under the action of the creep random load is as shown in formula 5:

$$formula 5$$

$${ɛ}_{c} ( t ) = \{ \begin{matrix}\frac{S ( t )}{{E}_{f}} \frac{2 {l}_{d} ( t )}{{l}_{c}} + \frac{2 {τ}_{f}}{{r}_{f} {E}_{f} {l}_{c}} {ζ}^{2} ( t ) - \frac{4 {τ}_{f} {l}_{d} ( t )}{{r}_{f} {E}_{f} {l}_{c}} ζ ( t ) - \frac{2 {τ}_{i}}{{r}_{f} {E}_{f} {l}_{c}} {( {l}_{d} ( t ) - ζ ( t ) )}^{2} + \\ \frac{2 {σ}_{f o}}{{E}_{f} {l}_{c}} ( \frac{{l}_{c}}{2} - {l}_{d} ( t ) ) + \frac{2 {r}_{f}}{ρ {E}_{f} {l}_{c}} \{ S ( t ) - \frac{2 {τ}_{f}}{{r}_{f}} ζ ( t ) - \frac{2 {τ}_{i}}{{r}_{f}} [ {l}_{d} ( t ) - ζ ( t ) ] - {σ}_{fo} \} \times \\ [ 1 - exp ( - ρ \frac{{l}_{c} / 2 - {l}_{d} ( t )}{{r}_{f}} ) ] - ( {α}_{c} - {α}_{f} ) Δ T , {l}_{d} ( t ) < \frac{{l}_{c}}{2} \\ \frac{S ( t )}{{E}_{f}} \frac{2 {l}_{d} ( t )}{{l}_{c}} + \frac{2 {τ}_{f}}{{r}_{f} {E}_{f} {l}_{c}} {ζ}^{2} ( t ) - \frac{4 {τ}_{f} {l}_{d} ( t )}{{r}_{f} {E}_{f} {l}_{c}} ζ ( t ) - \frac{2 {τ}_{i}}{{r}_{f} {E}_{f} {l}_{c}} {( {l}_{d} ( t ) - ζ ( t ) )}^{2} , \\ {l}_{d} ( t ) = \frac{{l}_{c}}{2}\end{matrix} ;$$

in the formula 5, ε_{c}(t) is the composite material strain, S(t) is a random load, E_{f} is a fiber elastic modulus, l_{d}(t) is an interface debonding length, l_{c} is a matrix crack spacing, τ_{f} is an oxidation region interface shear stress, r_{f} is a fiber radius, ζ(t) is an interface oxidation length, τᵢ is a slip region interface shear stress, σ_{fo} is an interface bonding region stress, ρ is a shear lag model parameter, α_{c} is a thermal expansion coefficient of the composite material, α_{f} is a thermal expansion coefficient of the fiber, and ΔT is a difference between a testing temperature and a preparation temperature.

The disclosure provides a method for predicting a creep fracture behavior of a woven ceramic matrix composite material considering a random load effect. In the embodiments provided by the disclosure, a fiber axial stress distribution equation under an action of a creep random load is obtained by analyzing a mesoscopic stress field of the woven ceramic matrix composite material under the action of the creep random load, according to a shear lag model, a random matrix cracking model, a fracture mechanical interface debonding criterion and a fiber failure model; a matrix crack spacing equation under an action of a creep random load is obtained according to the random matrix cracking model; an interface debonding length equation under an action of a creep random load is obtained according to the fracture mechanics interface debonding criterion, and an equation of the load bearing relationship between intact fibers and broken fibers and a fiber fracture probability equation under the action of the creep random load are obtained based on an overall load bearing criterion, and in turn the creep strain equation of the woven ceramic matrix composite material under the action of the random load is obtained, which is used to predict the creep fracture behavior of the woven ceramic matrix composite material considering a random load effect. The method provided by the disclosure considers the effects of random load factors on the creep fracture behavior of the woven ceramic matrix composite material and thus can accurately predict the creep fracture behavior of the woven ceramic matrix composite material affected by the random load, and improve the reliability and safety of the ceramic matrix composite material structural member in the use process.

### BRIEF DESCRIPTION OF THE DRAWINGS

FIG. 1 is a diagram of a shear lag unit cell model of a damaged region of a woven ceramic matrix composite material; and

FIG. 2 is a curve graph showing creep strain of the woven ceramic matrix composite material under actions of different random loads in embodiment 1.

### DETAILED DESCRIPTION OF THE EMBODIMENTS

The prediction method of a creep fracture behavior of a woven ceramic matrix composite material considering a random load effect, provided by the disclosure, comprises a plurality of parameters, and in order to clearly understand the disclosure, the parameters, the parameter symbols and the parameter meanings involved in the prediction method are explained, as shown in table 1.

TABLE 1
the parameters involved in the prediction method of a creep fracture behavior
of a woven ceramic matrix composite material considering random load effect

| parameter | symbol | acquisition method |
|---|---|---|
| fiber radius | r_{f} | obtained by measuring |
| oxidation region interface shear stress | τ_{f} | obtained by measuring |
| slip region interface shear stress | τᵢ | obtained by measuring |
| axial value | x | — |
| fiber volume content in composite material | V_{f} | obtained directly according to |
| | | preparation conditions |
| matrix volume content | Vₘ | obtained by subtracting V_{f} from |
| | | 1 |
| matrix elastic modulus | Eₘ | obtained by measuring |
| fiber volume content along stress loading | V_{f}_{_{—}}_{loading} | obtained directly |
| direction | | |
| fiber elastic modulus | E_{f} | obtained by measuring |
| composite material elastic modulus | E_{c} | obtained according to mixing |
| | | rate |
| fiber effective volume content coefficient | χ | obtained according to fiber |
| along stress loading direction | | weave dimension |
| shear lag model parameter | ρ | obtained by calculating shear lag |
| | | model |
| interface oxidation length | ζ(t) | obtained by measuring |
| fiber Weibull modulus | m_{f} | obtained by measuring |
| intact fibers bearing stress | S | obtained by calculating |
| random load | S(t) | obtained directly |
| fiber axial stress | σ_{f}(x, t) | obtained by calculating |
| fiber fracture probability | P(S) | obtained by calculating |
| fiber pulling length | [symbol] L [symbol] | obtained by calculating |
| matrix crack spacing | l_{c} | obtained by calculating |
| interface debonding length | l_{d}(t) | obtained by calculating |
| interface debonding energy | ξ_{d} | obtained by measuring |
| fiber characteristic strength | σ_{c} | obtained by measuring |
| stress | σ | obtained directly |
| interface bonding region stress | σ_{fo} | obtained according to shear lag |
| | | model |
| matrix initial cracking stress | σ_{mc} | obtained by measuring |
| residual thermal stress | σₜₕ | obtained by calculating |
| matrix cracking characteristic stress | σ_{R} | obtained by measuring |
| matrix Weibull modulus | m | obtained by measuring |
| thermal expansion coefficient of composite | α_{c} | obtained by measuring |
| material | | |
| thermal expansion coefficient of fiber | α_{f} | obtained by measuring |
| composite material strain | ε_{c}(t) | obtained by calculating |
| difference between testing temperature and | ΔT | obtained by using temperature |
| preparation temperature | | and preparation temperature |

Note:
The composite material represents a woven ceramic matrix composite material, the fibers represent fibers in the woven ceramic matrix composite material, the matrix represents a matrix in the woven ceramic composite material, the term “axial” refers to the stress loading direction, and the interface refers to the matrix/fiber interface.

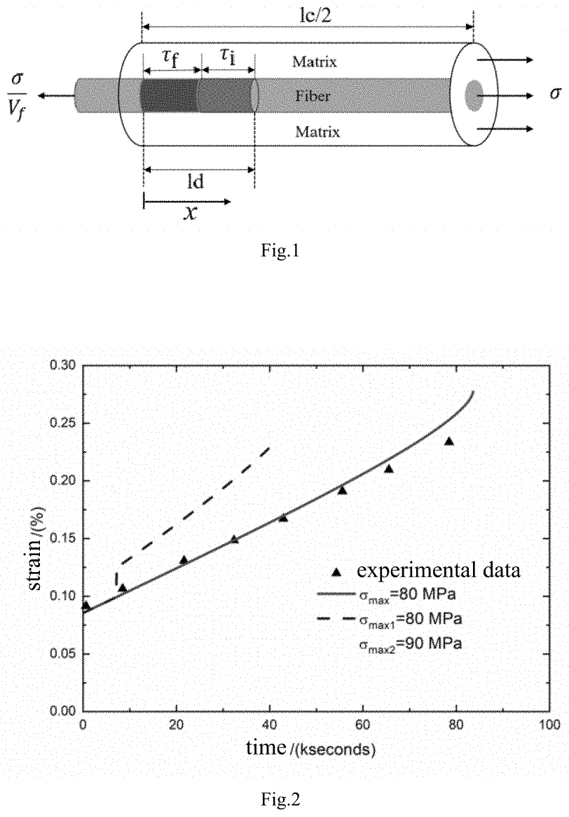

In order to further clearly describe the method for predicting a creep fracture behavior of a woven ceramic matrix composite material considering a random load effect, the disclosure optionally provides a diagram of a shear lag unit cell model of a damaged region of a woven ceramic matrix composite material (shown in FIG. 1) so as to further explain the meanings of some parameters existing in the disclosure.

As shown in FIG. 1, the woven ceramic matrix composite material comprises fibers and a matrix. Under the action of stress (σ), the fibers and the matrix in the damaged region of the woven ceramic matrix composite material can relatively move to form an oxidation region and a slip region of a fiber/matrix interface, and the friction force generated by relative movement between the fibers and the matrix is oxidation region interface shear stress (τ_{f}) and slip region interface shear stress (τᵢ); debonding length (l_{d}) is generated due to debonding between the fibers and the matrix interface; the debonding length l_{d} is divided into an interface slip region and an interface oxidation region.

Based on the description in table 1 and FIG. 1, the following description is made on the specific implementation process of the prediction method of creep fracture behavior of the woven ceramic matrix composite material considering a random load effect, provided by the present disclosure:

The disclosure provides a method for predicting a creep fracture behavior of a woven ceramic matrix composite material considering a random load effect, which comprises the following steps of:

(1) establishing a fiber axial stress distribution equation under an action of a creep random load according to a shear lag model, a random matrix cracking model, a fracture mechanical interface debonding criterion and a fiber failure model;

(2) establishing a matrix crack spacing equation under an action of a creep random load according to the random matrix cracking model;

(3) establishing an interface debonding length equation under the action of a creep random load by using the fiber axial stress distribution equation under the action of the creep random load obtained in step (1) and the matrix crack spacing equation under the action of the creep random load obtained in step (2), according to the fracture mechanics interface debonding criterion;

(4) establishing an equation of the load bearing relationship between intact fibers and broken fibers and a fiber fracture probability equation under the action of the creep random load according to an overall load bearing criterion, Weibull distribution, a mesoscopic stress field of a damaged region of the woven ceramic matrix composite material, the matrix crack spacing equation under the action of the creep random load obtained in step (2) and the interface debonding length equation under the action of the creep random load obtained in step (3); and

(5) establishing a creep strain equation under the action of the creep random load by using the fiber axial stress distribution equation under the action of the creep random load obtained in step (1), the matrix crack spacing equation under the action of the creep random load obtained in step (2), and the equation of the load bearing relationship between the intact fibers and the broken fibers and the fiber fracture probability equation under the action of the creep random load obtained in step (4), according to the overall load bearing criterion, to predict a creep fracture behavior of a woven ceramic matrix composite material under the action of the creep random load.

The fiber axial stress distribution equation under an action of a creep random load is established according to the shear lag model, the random matrix cracking model, the fracture mechanical interface debonding criterion and the fiber failure model in the present disclosure.

In the present disclosure, the fiber axial stress distribution equation under the action of the creep random load is optionally as shown in formula 1:

$$formula 1$$

$${σ}_{f} ( x , t ) = \{ \begin{matrix}s ( t ) - \frac{2 {τ}_{f}}{{r}_{f}} x , x ∈ [ 0 , ζ ( t ) ] \\ S ( t ) - \frac{2 {τ}_{f}}{{r}_{f}} ζ ( t ) - \frac{2 {τ}_{i}}{{r}_{f}} ( x - ζ ( t ) ) , x ∈ [ ζ ( t ) , {l}_{d} ( t ) ] \\ {σ}_{fo} + [ S ( t ) - {σ}_{fo} - \frac{2 {τ}_{f}}{{r}_{f}} ζ ( t ) - \frac{2 {τ}_{i}}{{r}_{f}} ( {l}_{d} ( t ) - ζ ( t ) ) ] exp ( - ρ \frac{x - {l}_{d} ( t )}{{r}_{f}} ) , \\ x ∈ [ {l}_{d} ( t ) , \frac{{l}_{c}}{2} ]\end{matrix} ;$$

In the formula 1, σ_{f}(x,t) is a fiber axial stress, S(t) is a random load, τ_{f} is an oxidation region interface shear stress, r_{f} is a fiber radius, x is an axial value, ζ(t) is an interface oxidation length, τᵢ is a slip region interface shear stress, l_{d}(t) is an interface debonding length, τ_{fo} is an interface bonding region stress, ρ is a shear lag model parameter, and l_{c} is a matrix crack spacing.

In the present disclosure, the shear lag model parameter (ρ) is preferably obtained by calculating the shear lag model, and the shear lag model is preferably a BHE shear lag model. The present disclosure does not require any special calculation, and can be implemented by adopting calculation methods well known to those skilled in the art.

As shown in the formula 1, when the fiber axial stress distribution under the action of random load is researched according to the present disclosure, a region section at ½ of spacing from a matrix crack to an adjacent matrix crack is preferably researched, and the region section is more preferably divided into an interface oxidation region [0˜ζ(t)], an interface slip region [ζ(t)˜ld(t)] and an interface debonding region [ld(t)˜lc/2], and different calculation methods are provided for different regions so as to improve an accuracy of a stress distribution prediction result. When the condition, x =ζ(t), is met, the fiber axial stress may be substituted into any formula, preferably into a formula for the interface oxidation region, for calculation; when the condition, x=l_{d}(t), is met, the fiber axial stress can be substituted into any formula, preferably into a formula for the interface debonding region, for calculation.

The matrix crack spacing equation under an action of a creep random load is established according to the random matrix cracking model in the present disclosure.

The method for establishing the matrix crack spacing equation under the action of the creep random load is not particularly limited by the disclosure, and the method well known to those skilled in the art can be adopted. In the present disclosure, the matrix crack spacing equation under the action of the creep random load is as shown in formula 2:

$${l}_{c} = {r}_{f} \frac{{V}_{m} {E}_{m}}{χ {V}_{f} {E}_{c}} \frac{{σ}_{R}}{2 {τ}_{i}} Λ {\{ 1 - exp [ - {( \frac{σ - ( {σ}_{mc} - {σ}_{th} )}{( {σ}_{R} - {σ}_{th} ) - ( {σ}_{mc} - {σ}_{th} )} )}^{m} ] \}}^{1} ; \qquad formula 2$$

In the formula 2, Vₘ is a matrix volume content, Em is a matrix elastic modulus, x is fiber effective volume content coefficient along a stress loading direction, V_{f} is fiber volume content in the composite material, E_{c} is the composite material elastic modulus, σ_{R} is a matrix cracking characteristic stress, σ is a stress, σ_{mc} is a matrix initial cracking stress, σₜₕ is a residual thermal stress, and m is a matrix Weibull modulus. The other parameters are consistent with those represented as the consistent symbols appearing in the expression in the foregoing technical solution, and are not described again here.

In the present disclosure, the fiber effective volume content coefficient x of the woven ceramic matrix composite material along the stress loading direction is preferably obtained according to the following formula:

$$χ = \frac{{V}_{f\_loading}}{{V}_{f}} ;$$

Wherein, V_{f_loading} is the fiber volume content along the stress loading direction; V_{f} is the fiber volume content of the woven ceramic matrix composite material.

In the present disclosure, the fiber effective volume content coefficient (χ) along the stress loading direction is related to a weave dimension of the fibers in the woven ceramic matrix composite material:

when the weave dimension of the woven ceramic matrix composite material is 2, χ is 0.5;

when the weave dimension of the woven ceramic matrix composite material is 2.5, χ is 0.75; and

when the weave dimension of the woven ceramic matrix composite material is 3, χ is 0.93.

In a specific embodiment of the present disclosure, the dimension of the woven ceramic matrix composite material is preferably 2.

The interface debonding length equation under the action of the creep random load by using the fiber axial stress distribution equation under the action of the creep random load and the matrix crack spacing equation under the action of the creep random load, according to the fracture mechanics interface debonding criterion in the present disclosure.

In the present disclosure, the interface debonding length equation under the action of the creep random load is preferably as shown in formula 3:

$${l}_{d} ( t ) = ( 1 - \frac{{τ}_{f}}{{τ}_{i}} ) ζ ( t ) + \frac{{r}_{f}}{2} ( \frac{{V}_{m} {E}_{m} S}{{E}_{c} {τ}_{i}} - \frac{1}{ρ} ) - \sqrt{{( \frac{{r}_{f}}{2 ρ} )}^{2} - \frac{{r}_{f}^{2} {V}_{f} {V}_{m} {E}_{f} {E}_{m} {S}^{2}}{4 {E}_{c}^{2} {τ}_{i}^{2}} ( 1 - \frac{σ}{{V}_{f} S} ) + \frac{{r}_{f} {V}_{m} {E}_{f} {E}_{m}}{{E}_{c} {τ}_{i}^{2}} {ξ}_{d}} ; \qquad formula 3$$

In the formula 3, l_{d}(t) is the interface debonding length, τ_{f} is the oxidation region interface shear stress, ζ(t) is the interface oxidation length, S represents the intact fibers bearing stress, E_{f} is the fiber elastic modulus, and ξ_{d} is the interface debonding energy. The other parameters are consistent with those represented as the consistent symbols appearing in the expression in the foregoing technical solution, and are not described again here.

The equation of the load bearing relationship between intact fibers and broken fibers and the fiber fracture probability equation under the action of the creep random load are established according to an overall load bearing criterion, Weibull distribution, a mesoscopic stress field of a damaged region of the woven ceramic matrix composite material, the matrix crack spacing equation under the action of the creep random load and the interface debonding length equation under the action of the creep random load in the present disclosure.

In the present disclosure, the equation of the load bearing relationship between the intact fibers and the broken fibers under the action of the creep random load is preferably as shown in formula 4-1:

$$\frac{σ}{{V}_{f}} = S ( 1 - P ( S ) ) + \frac{2 {τ}_{f}}{{r}_{f}} 〈 L 〉 P ( S ) ; \qquad formula 4 \text{-} 1$$

The fiber fracture probability equation under the action of the creep random load is preferably as shown in formula 4-2:

$$P ( S ) = 1 - exp [ - {( \frac{S}{{σ}_{c}} )}^{{m}_{f} + 1} ] ; \qquad formula 4 \text{-} 2$$

In the formulas 4-1 and 4-2, P(S) is a fiber fracture probability, [symbol] L [symbol] is a fiber pulling length, σ_{c} is a fiber characteristic strength, and m_{f} is fiber Weibull modulus. The other parameters are consistent with those represented as the consistent symbols appearing in the expression in the foregoing technical solution, and are not described again here.

The creep strain equation under the action of the creep random load is established by using the fiber axial stress distribution equation under the action of the creep random load, the matrix crack spacing equation under the action of the creep random load, and the equation of the load bearing relationship between the intact fibers and the broken fibers and the fiber fracture probability equation under the action of the creep random load, according to the overall load bearing criterion, to predict a creep fracture behavior of a woven ceramic matrix composite material under the action of the creep random load in the present disclosure.

In the present disclosure, the creep strain equation under the action of the creep random load is preferably as shown in formula 5:

$$formula 5$$

$${ɛ}_{c} ( t ) = \{ \begin{matrix}\frac{S ( t )}{{E}_{f}} \frac{2 {l}_{d} ( t )}{{l}_{c}} + \frac{2 {τ}_{f}}{{r}_{f} {E}_{f} {l}_{c}} {ζ}^{2} ( t ) - \frac{4 {τ}_{f} {l}_{d} ( t )}{{r}_{f} {E}_{f} {l}_{c}} ζ ( t ) - \frac{2 {τ}_{i}}{{r}_{f} {E}_{f} {l}_{c}} {( {l}_{d} ( t ) - ζ ( t ) )}^{2} + \\ \frac{2 {σ}_{f o}}{{E}_{f} {l}_{c}} ( \frac{{l}_{c}}{2} - {l}_{d} ( t ) ) + \frac{2 {r}_{f}}{ρ {E}_{f} {l}_{c}} \{ S ( t ) - \frac{2 {τ}_{f}}{{r}_{f}} ζ ( t ) - \frac{2 {τ}_{i}}{{r}_{f}} [ {l}_{d} ( t ) - ζ ( t ) ] - {σ}_{fo} \} \times \\ [ 1 - exp ( - ρ \frac{{l}_{c} / 2 - {l}_{d} ( t )}{{r}_{f}} ) ] - ( {α}_{c} - {α}_{f} ) Δ T , {l}_{d} ( t ) < \frac{{l}_{c}}{2} \\ \frac{S ( t )}{{E}_{f}} \frac{2 {l}_{d} ( t )}{{l}_{c}} + \frac{2 {τ}_{f}}{{r}_{f} {E}_{f} {l}_{c}} {ζ}^{2} ( t ) - \frac{4 {τ}_{f} {l}_{d} ( t )}{{r}_{f} {E}_{f} {l}_{c}} ζ ( t ) - \frac{2 {τ}_{i}}{{r}_{f} {E}_{f} {l}_{c}} {( {l}_{d} ( t ) - ζ ( t ) )}^{2} , \\ {l}_{d} ( t ) = \frac{{l}_{c}}{2}\end{matrix} ;$$

In the formula 5, ε_{c}(t) is the composite material strain, α_{c} is a thermal expansion coefficient of the composite material, α_{f} is a thermal expansion coefficient of the fibers, and ΔT is a difference between a testing temperature and a preparation temperature. The other parameters are consistent with those represented as the consistent symbols appearing in the expression in the foregoing technical solution, and are not described again here.

In the present disclosure, the creep strain equation under the action of the creep random load is established, to predict a creep fracture behavior of the woven ceramic matrix composite material under the action of the creep random load, and it can monitor a damage to the woven ceramic matrix composite material caused by the creep random load and improve the safety of the woven ceramic matrix composite material structure in the practical engineering application process.

In the following, the technical solutions in the embodiments of the present disclosure will be clearly and completely described with reference to the embodiments of the present disclosure. Obviously, the described embodiments are only a part of the embodiments of the present disclosure, rather than all the embodiments. Based on the embodiments of the present disclosure, all other embodiments obtained by a person of ordinary skill in the art without involving any inventive effort are within the scope of the present disclosure.

### Embodiment 1

According to the prediction method provided by the disclosure, a desired creep strain equation of the woven ceramic matrix composite material under the action of the creep random load is established, the woven ceramic matrix composite material (SiC/SiC) is taken as a test sample, and the creep fracture behavior of the woven ceramic matrix composite material under the action of the creep random load is predicted under the conditions of σₘₐₓ=80 MPa, σₘₐₓ₁=80 MPa, σₘₐₓ₂=90 MPa.

providing parameters: V_{f}=30% E_{f}=270 GPa, Eₘ=400 GPa, r_{f}=7 μm, m=3, α_{f}=3.5×10−6/° C., ΔT=−200° C. (the preparation temperature of the composite material is 1000° C., and the testing temperature of the composite material is 800° C.), and χ is 0.5.

And then, according to the equations shown in the formula 1, the formula 2, the formula 3, the formula 4-1, the formula 4-2 and the formula 5, a creep strain equation of the woven ceramic matrix composite material considering the random load effect is established, and the creep fracture behavior of the woven ceramic matrix composite material is predicted. FIG. 2 shows curves of the creep strain of the woven ceramic matrix composite material under actions of different random loads, and it can be seen from FIG. 2 that the predicted result is consistent with the experimental data under the normal stress; when a random load is applied, the random strain is increased, the creep life is reduced, namely the random load affects the creep life of the woven ceramic matrix composite material, which shows that the creep fracture behavior of the woven ceramic matrix composite material can be accurately predicted by the method provided by the disclosure.

The foregoing is only preferred embodiments of the present disclosure, and it should be noted that, for those skilled in the art, various modifications and amendments can be made without departing from the principle of the present disclosure, and these modifications and amendments should also be considered within the protection scope of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed:

1. A method for predicting a creep fracture behavior of a woven ceramic matrix composite material considering a random load effect, comprising:
(1) establishing a fiber axial stress distribution equation under an action of a creep random load according to a shear lag model, a random matrix cracking model, a fracture mechanical interface debonding criterion and a fiber failure model;
(2) establishing a matrix crack spacing equation under an action of a creep random load according to the random matrix cracking model;
(3) establishing an interface debonding length equation under the action of a creep random load by using the fiber axial stress distribution equation under the action of the creep random load obtained in step (1) and the matrix crack spacing equation under the action of the creep random load obtained in step (2), according to the fracture mechanics interface debonding criterion;
(4) establishing an equation of the load bearing relationship between intact fibers and broken fibers and a fiber fracture probability equation under the action of the creep random load according to an overall load bearing criterion, Weibull distribution, a mesoscopic stress field of a damaged region of the woven ceramic matrix composite material, the matrix crack spacing equation under the action of the creep random load obtained in step (2) and the interface debonding length equation under the action of the creep random load obtained in step (3); and
(5) establishing a creep strain equation under the action of the creep random load by using the fiber axial stress distribution equation under the action of the creep random load obtained in step (1), the matrix crack spacing equation under the action of the creep random load obtained in step (2), and the equation of the load bearing relationship between the intact fibers and the broken fibers and the fiber fracture probability equation under the action of the creep random load obtained in step (4), according to the overall load bearing criterion, to predict the creep fracture behavior of the woven ceramic matrix composite material under the action of the creep random load.

2. The method according to claim 1, wherein in step (1), the fiber axial stress distribution equation under the action of the creep random load is as shown in formula 1:
$$formula 1$$
$${σ}_{f} ( x , t ) = \{ \begin{matrix}S ( t ) - \frac{2 {τ}_{f}}{{r}_{f}} x , x ∈ [ 0 , ζ ( t ) ] \\ S ( t ) - \frac{2 {τ}_{f}}{{r}_{f}} ζ ( t ) - \frac{2 {τ}_{i}}{{r}_{f}} ( x - ζ ( t ) ) , x ∈ [ ζ ( t ) , {l}_{d} ( t ) ] \\ {σ}_{f o} + [ S ( t ) - {σ}_{f o} - \frac{2 {τ}_{f}}{{r}_{f}} ζ ( t ) - \frac{2 {τ}_{i}}{{r}_{f}} ( {l}_{d} ( t ) - ζ ( t ) ) ] exp ( - ρ \frac{x - {l}_{d} ( t )}{{r}_{f}} ) , \\ x ∈ [ {l}_{d} ( t ) , \frac{{l}_{c}}{2} ]\end{matrix} ;$$
in the formula 1, σ_{f}(x,t) is a fiber axial stress, S(t) is a random load, τ_{f} is an oxidation region interface shear stress, r_{f} is a fiber radius, x is an axial value, ζ(t) is an interface oxidation length, τᵢ is a slip region interface shear stress, l_{d}(t) is an interface debonding length, σ_{fo} is an interface bonding region stress, ρ is a shear lag model parameter, and l_{c} is a matrix crack spacing.

3. The method according to claim 1, wherein in step (2), the matrix crack spacing equation under the action of the creep random load is as shown in formula 2:
$${l}_{c} = {r}_{f} \frac{{V}_{m} {E}_{m}}{χ {V}_{f} {E}_{c}} \frac{{σ}_{R}}{2 {τ}_{i}} Λ {\{ 1 - exp [ - {( \frac{σ - ( {σ}_{mc} - {σ}_{th} )}{( {σ}_{R} - {σ}_{th} ) - ( {σ}_{mc} - {σ}_{th} )} )}^{m} ] \}}^{1} ; \qquad formula 2$$
in the formula 2, l_{c} is a matrix crack spacing, r_{f} is a fiber radius, Vₘ is matrix volume content, Em is a matrix elastic modulus, χ is a fiber effective volume content coefficient along a stress loading direction, V_{f} is fiber volume content in the composite material, E_{c} is a composite material elastic modulus, σ_{R} is a matrix cracking characteristic stress, τᵢ is a slip region interface shear stress, σ is a stress, σ_{mc} is a matrix initial cracking stress, σₜₕ is a residual thermal stress, and m is a matrix Weibull modulus.

4. The method according to claim 1, wherein in step (3), the interface debonding length equation under the action of the creep random load is as shown in formula 3:
$${l}_{d} ( t ) = ( 1 - \frac{{τ}_{f}}{τ} ) ζ ( t ) + \frac{{r}_{f}}{2} ( \frac{{V}_{m} {E}_{m} S}{{E}_{c} {τ}_{i}} - \frac{1}{ρ} ) - \sqrt{{( \frac{{r}_{f}}{2 ρ} )}^{2} - \frac{{r}_{f}^{2} {V}_{f} {V}_{m} {E}_{f} {E}_{m} {S}^{2}}{4 {E}_{c}^{2} {τ}_{i}^{2}} ( 1 - \frac{σ}{{V}_{f} S} ) + \frac{{r}_{f} {V}_{m} {E}_{f} {E}_{m}}{{E}_{c} {τ}_{i}^{2}} {ξ}_{d}} ; \qquad formula 3$$
in the formula 3, l_{d}(t) is an interface debonding length, τ_{f} is an oxidation region interface shear stress, τᵢ is a slip region interface shear stress, ζ(t) is an interface oxidation length, r_{f} is a fiber radius, Vₘ is matrix volume content, Eₘ is a matrix elastic modulus, S represents an intact fibers bearing stress, Ec is a composite material elastic modulus, ρ is a shear lag model parameter, V_{f} is fiber volume content in the composite material, E_{f} is a fiber elastic modulus, σ is a stress, and ξ_{d} is interface debonding energy.

5. The method according to claim 1, wherein in step (4), the equation of the load bearing relationship between the intact fibers and the broken fibers under the action of the creep random load is as shown in formula 4-1:
$$\frac{σ}{{V}_{f}} = S ( 1 - P ( S ) ) + \frac{2 {τ}_{f}}{{r}_{f}} 〈 L 〉 P ( S ) ; \qquad formula 4 \text{-} 1$$
the fiber fracture probability equation under the action of the creep random load is as shown in formula 4-2:
$$P ( S ) = 1 - exp [ - {( \frac{S}{{σ}_{c}} )}^{{m}_{f} + 1} ] ; \qquad formula 4 \text{-} 2$$
in the formulas 4-1 and 4-2, σ is a stress, V_{f} is fiber volume content in the composite material, S represents an intact fibers bearing stress, P(S) is a fiber fracture probability, τ_{f} is an oxidation region interface shear stress, r_{f} is a fiber radius, [symbol] L [symbol] is a fiber pulling length, σ_{c} is a fiber characteristic strength, and m_{f} is a fiber Weibull modulus.

6. The method according to claim 1, wherein in step (5), the creep strain equation under the action of the creep random load is as shown in formula 5:
$$formula 5$$
$${ɛ}_{c} ( t ) = \{ \begin{matrix}\frac{S ( t )}{{E}_{f}} \frac{2 {l}_{d} ( t )}{{l}_{c}} + \frac{2 {τ}_{f}}{{r}_{f} {E}_{f} {l}_{c}} {ζ}^{2} ( t ) - \frac{4 {τ}_{f} {l}_{d} ( t )}{{r}_{f} {E}_{f} {l}_{c}} ζ ( t ) - \frac{2 {τ}_{i}}{{r}_{f} {E}_{f} {l}_{c}} {( {l}_{d} ( t ) - ζ ( t ) )}^{2} + \\ \frac{2 {σ}_{f o}}{{E}_{f} {l}_{c}} ( \frac{{l}_{c}}{2} - {l}_{d} ( t ) ) + \frac{2 {r}_{f}}{ρ {E}_{f} {l}_{c}} \{ S ( t ) - \frac{2 {τ}_{f}}{{r}_{f}} ζ ( t ) - \frac{2 {τ}_{i}}{{r}_{f}} [ {l}_{d} ( t ) - ζ ( t ) ] - {σ}_{fo} \} \times \\ [ 1 - exp ( - ρ \frac{{l}_{c} / 2 - {l}_{d} ( t )}{{r}_{f}} ) ] - ( {α}_{c} - {α}_{f} ) Δ T , {l}_{d} ( t ) < \frac{{l}_{c}}{2} \\ \frac{S ( t )}{{E}_{f}} \frac{2 {l}_{d} ( t )}{{l}_{c}} + \frac{2 {τ}_{f}}{{r}_{f} {E}_{f} {l}_{c}} {ζ}^{2} ( t ) - \frac{4 {τ}_{f} {l}_{d} ( t )}{{r}_{f} {E}_{f} {l}_{c}} ζ ( t ) - \frac{2 {τ}_{i}}{{r}_{f} {E}_{f} {l}_{c}} {( {l}_{d} ( t ) - ζ ( t ) )}^{2} , \\ {l}_{d} ( t ) = \frac{{l}_{c}}{2}\end{matrix} ;$$
in the formula 5, ε_{c}(t) is the composite material strain, S(t) is a random load, E_{f} is a fiber elastic modulus, l_{d}(t) is an interface debonding length, l_{c} is a matrix crack spacing, τ_{f} is an oxidation region interface shear stress, r_{f} is a fiber radius, ζ(t) is an interface oxidation length, τᵢ is a slip region interface shear stress, σ_{fo} is an interface bonding region stress, ρ is a shear lag model parameter, α_{c} is a thermal expansion coefficient of the composite material, α_{f} is a thermal expansion coefficient of the fiber, and ΔT is a difference between a testing temperature and a preparation temperature.
